(19) United States
(12) Patent Application Publication
(10) Pub. No.: US 2021/0206087 A1
(43) Pub. Date: Jul. 8, 2021

(54) THREE-DIMENSIONAL PRINTER

(71) Applicant: HEWLETT-PACKARD DEVELOPMENT COMPANY, L.P., Spring, TX (US)

(72) Inventors: John GEILE, Vancouver, WA (US); Daniil POPOV, Vancouver, WA (US); Pierre J. KAISER, Vancouver, WA (US)

(73) Assignee: HEWLETT-PACKARD DEVELOPMENT COMPANY, L.P., Spring, TX (US)

(21) Appl. No.: 16/075,688

(22) PCT Filed: Jul. 28, 2017
(86) PCT No.: PCT/US2017/044339

§ 371 Date: Aug. 6, 2018

(51) Int. Cl. B29C 64/329; B29C 64/153; B29C 64/188; B29C 64/209; B29C 64/214; B29C 64/236

(52) U.S. Cl. CPC B29C 64/329; B29C 64/153; B29C 64/188; B33Y 10/00; B29C 64/214; B29C 64/236; B29C 64/209

(57) ABSTRACT

A three-dimensional (3D) printer and method including a vessel to discharge build material for the 3D printer to form a 3D object from the build material. The vessel includes a baffle or restrictor to alter flow of build material discharging from the vessel.

### BACKGROUND

Three-dimensional (3D) printing may produce a 3D object. In particular, a 3D printer may add successive layers of build material, such as powder, to a build platform. The 3D printer may selectively solidify portions of each layer under computer control to produce the 3D object. The material may be powder, or powder-like material, including metal, plastic, composite material, and other powders. The objects formed can be various shapes and geometries, and produced via a model such as a 3D model or other electronic data source. The fabrication may involve laser melting, laser sintering, electron beam melting, or thermal fusion, and so on. The model and automated control may facilitate the layered manufacturing and additive fabrication. The 3D printed objects may be intermediate or end-use products, as well as prototypes. Product applications may include machine parts, aerospace parts, medical devices (e.g., implants), automobile parts, fashion products, structural and conductive metals, ceramics, and other applications.

### DESCRIPTION OF THE DRAWINGS

Certain examples are described in the following detailed description and in reference to the drawings, in which:

FIG. 1 is a block diagram of a 3D printer having a provision vessel in accordance with examples of the present techniques;

FIG. 2 is a block diagram of a 3D printer having a provision vessel and a material supply surface in accordance with examples of the present techniques;

FIG. 3 is a perspective view of internal region of a 3D printer having a provision vessel in accordance with examples of the present techniques;

FIG. 4 is a side cross-section view of a provision vessel over a supply surface in accordance with examples of the present techniques;

FIG. 5 is a side cross-section view of the provision vessel of FIG. 4 in movement over the supply surface in accordance with examples of the present techniques;

FIG. 6 is a perspective view of an internal material provision vessel of a 3D printer in accordance with examples of the present techniques;

FIG. 7 is a perspective view of an internal material provision vessel of a 3D printer in accordance with examples of the present techniques;

FIG. 8 is a cross-section view of an internal material provision dispense vessel of a 3D printer in accordance with examples of the present techniques;

FIG. 9 is a cross-section view of an internal material provision vessel of a 3D printer in accordance with examples of the present techniques;

FIG. 10 is a cross-section view of an internal material provision vessel of a 3D printer in accordance with examples of the present techniques;

FIG. 11 is a diagram of a material provision vessel of a 3D printer dispensing build material in accordance with examples of the present techniques;

FIG. 12 is a diagram of a material provision vessel of a 3D printer dispensing build material in accordance with examples of the present techniques;

FIG. 13 is a diagram of a material provision vessel of a 3D printer dispensing build material in accordance with examples of the present techniques;

FIG. 14 is a diagram of a material provision vessel of a 3D printer dispensing build material in accordance with examples of the present techniques;

FIG. 15 is a diagram of a 3D printer having a material provision vessel in accordance with examples of the present techniques;

FIG. 16 is a diagram of a 3D printer having a material provision vessel in accordance with examples of the present techniques;

FIG. 17 is a block flow diagram of a method of operating a 3D printer having am internal material provision vessel in accordance with examples of the present techniques; and

FIG. 18 is a perspective view of a 3D printer having a material provision vessel in accordance with examples of the present techniques.

### DETAILED DESCRIPTION

Examples of the present techniques include a 3D printer having a vessel to discharge build material for the 3D printer to form a 3D object from the build material. The build material may be in a powder form. Moreover, the vessel may be disposed internal within the 3D printer. Further, the vessel includes a baffle or restrictor to alter flow of build material discharging from the vessel. The baffle or restrictor may be in the internal volume of the vessel.

The vessel may be labeled as a provision vessel, material provision vessel, dosing vessel, dosing container, dosing box, and the like. In some examples, the vessel may facilitate provision of an amount of build material for each layer of build material on a build platform. The printer may form a 3D object layer-by-layer from successive layers of build material on the build platform.

In some examples, the provision vessel may discharge the build material for a powder spreader. The provision vessel includes the baffle or internal restrictor to alter flow of build material discharging from the provision vessel through an exit opening of the provision vessel. The powder spreader distributes the discharged build material across a build platform of the 3D printer. Again, the 3D printer may generate a 3D object on the build platform from the build material.

In certain examples, the 3D printer has a supply surface or dosing surface that receives build material from the provision vessel. In particular examples, the provision vessel may operably move across the supply surface such that the provision vessel discharges, releases, or distributes an amount of build material as a generally rectangular prism or other shape onto the supply surface. In one example, the formation of the build material on the supply surface may be called a ribbon of build material. The powder spreader may distribute the build material from the supply surface to across the build platform. In particular, the powder spreader may push or otherwise disperse the ribbon of build material from the supply surface to across the build platform. After the powder spreader has distributed the build material from the supply surface, the provision vessel may discharge another ribbon of build material onto the supply surface, and the powder spreader distribute that ribbon as the next layer of build material across the build platform. An issue is that the ribbon on the supply surface may be irregular in thickness or density due to discharge of build material from a front portion of the provision vessel exit as the provision vessel moves across the supply surface. As discussed below, the provision vessel may have a baffle or internal restrictor to inhibit such discharge of material from the front portion of the exit or discharge opening of the provision vessel.

Lastly, while various examples and printer components are discussed below, it should be emphasized that the material provision vessel having the baffle(s) may be relevant generally to any 3D printer forming a ribbon or layer of build material and in which uniformity in thickness or density may be desired. Indeed, many different types of 3D printers may employ the material provision vessel to apply a layer of build material to a supply surface or build platform. In examples, the provision vessel may apply build material to a supply surface, such as a dosing surface or supply deck, to make available build material for the build platform. In other examples, the provision vessel may apply the build material directly to the build platform or other work area in which the 3D object is formed. Additional configurations may be accommodated.

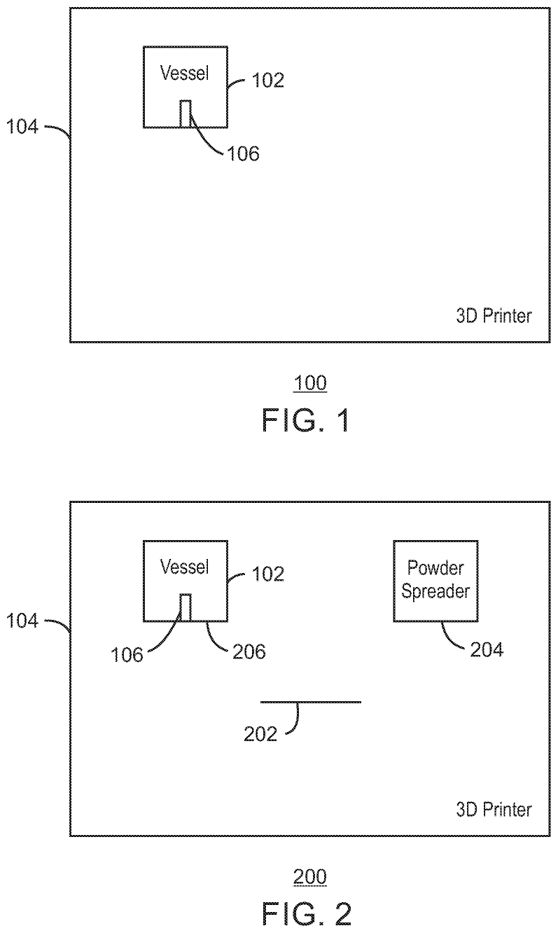

FIG. 1 is 3D printer 100 having a material provision vessel 102 disposed internal within the housing 104 of the printer 100. The provision vessel 102 may be a material dosing container, hopper, or box. The provision vessel 102 may be metal, plastic, or of other construction. The material provision vessel 102 discharges build material for a build platform. The 3D printer 100 in 3D printing forms a 3D object on the build platform from build material.

The printer 100 includes a restrictor or baffle 106 disposed internal in the material provision vessel 102 to alter flow of build material discharging from the material provision vessel 102. In some examples, the baffle 106 may be multiple baffles. As discussed below, the baffle 106 may provide for a more uniform distribution of build material from the material provision vessel 102 for supply of build material for the 3D printing.

The 3D printing may use one of selective layer sintering (SLS), selective heat sintering (SHS), electron beam melting (EBM), thermal fusion, or other 3D printing and AM techniques to generate the 3D object from the build material. The build material may be powder, powder-like, or in powder form. In some examples, the powder may exhibit fluid-like flow behavior. The build material may be different materials including polymers, plastics, metals, ceramics, and so on.

In examples of build-material supply to the provision vessel 102, the provision vessel may receive build material from a conveying system through, for example, a dispense vessel, and the like. For a particular example, the provision vessel 102 receives build material from the dispense vessel through a feeder. In one implementation, the provision vessel 102 is disposed adjacent and below the feeder.

FIG. 2 is a 3D printer 200 having the material provision vessel 102 disposed internal within the housing 104 of the printer 200. The baffle(s) 106 is disposed internal in the material provision vessel 102 to alter flow of build material discharging from the material provision vessel 102 to the supply surface 202. As mentioned, the build material may include powder including plastic, polymer, metal, glass, ceramic, or any combinations thereof.

In the illustrated example, the material provision vessel 102 discharges build material onto the supply surface 202 in the 3D printer 200. The supply surface 202 may be a supply deck, supply platform, dosing surface, or other source surface or device for build material for the 3D printing, such as for the powder spreader 204 or a build platform. In some examples, a powder spreader 204 or other build-material applicator distributes the build material from the supply surface 202 to across a build platform.

Indeed, examples may be directed to a 3D printer having a build platform to form a 3D object from build material such as powder. The 3D printer may include the material provision vessel 102 to discharge build material for the powder spreader 204 to distribute the build material across the build platform. In particular, as mentioned, the provision vessel 102 may discharge the build material to the supply surface 202. The supply surface 202 may be adjacent to the build platform in certain instances. In operation, the provision vessel 102 may move in some examples to discharge the build material relatively evenly on the supply surface 202. The powder spreader 204 may then move to relocate the build material from the supply surface 202 to across the build platform. Such provisioning of build material to the supply surface and spreading of build material from the supply surface to across the build platform may be repeated for each layer of the 3D product being formed.

The provision vessel 102 may be a hopper, a container, a box, and the like. In examples, the provision vessel 102 may dose or facilitate dosing an amount of build material for the powder spreader 204 and the build platform. In one example, the provision vessel 102 is a dosing box. In examples, the provision vessel 102 may have an exit 206 to release the build material onto the supply surface 202. As mentioned, the supply surface 202 may be adjacent the build platform. The exit 206 may be an exit opening, exit port, discharge port, and the like. The exit 206 opening of the provision vessel 102 may be square, rectangular, circular, an irregular geometry or other shape, and in some examples, is defined at least partially by a wall or external wall(s) of the provision vessel 102.

The provision vessel 102 may have the restrictor or baffle 106 to impact or alter flow of the build material to facilitate a substantially constant rate and direction of build material discharging from the provision vessel 102. Again, the restrictor or baffle 106 may be disposed in the interior volume of the provision vessel 102. In some examples with a restrictor employed, the restrictor is not a valve, a feeder, or the exit 206 itself. The restrictor or baffle 106 may be one or more restrictors or baffles 106. The restrictor or baffle 106 may reduce the exit 206 cross-sectional free area perpendicular to the build-material flow discharging through the exit 206 of the provision vessel 102 to facilitate thickness uniformity (and density uniformity) of the build material across the supply surface 202.

In examples, the restrictor or baffle(s) 106 may reduce discharge of material from a front portion of the provision vessel 102 as the provision vessel moves 102 across the supply surface 202, including when the provision vessel 102 starts or stops moving. Such may reduce waste of build material, as discussed below. Such may also encourage that discharge is primarily from a back portion of the provision vessel 102 to promote uniformity of applied build material on the surface 202. The restrictor or baffle 106 may account for pressure head of the build material in the provision vessel 102, friction applied on the build material within the vessel 202, and friction applied to the build material discharging at the surface 202, and so on. The friction with the vessel 102 may be labeled as internal friction. The friction applied to the build material at the surface 202 may be labeled as external friction.

The restrictor or baffle 106 may promote internal friction reducing discharge flow in some examples. In one example, the baffle 106 is a single baffle disposed in a central region of the exit 206 forming two zones of the exit 206 on each side of the restrictor or baffle 106. In another example, the restrictor or baffle 106 is multiple baffles. For one design, the multiple baffles 106 may have a length generally corresponding to the length or radius of the exit 206 or discharge port. The baffles 106 may have a vertical orientation. In other words, the baffle 106 height surface generally parallel to flow of build material may be longer than the baffle 106 width surface generally perpendicular to flow of build material. The baffles 106 can also have an angled orientation or other configurations. Lastly, while movement of the provision vessel 102 across the supply surface 202 is described, the provision vessel 102 may operate static and the supply surface 202 moves. In general, relative movement between the provision vessel 102 and the supply surface 202 may discharge or release build material from the provision vessel 102 onto the supply surface 202.

In certain examples, the powder spreader 204 includes a roller or mechanical arm, or the like, to dislocate the build material from the supply surface 202 to the build platform. As discussed below, a movement device in some examples may move the powder spreader 204 or facilitate operation of the powder spreader 204 over the build platform. Again, the 3D printer 200 may form a 3D object from successive layers of the build material on the build platform. To form the 3D object, 3D printer 200 may have an energy source to apply energy to the build material on the build platform. The movement and positioning of the energy source over the build platform 406, and the application of energy to the build material in certain examples, may be per a 3D model under computer control. Further, in particular examples, a print liquid may be employed, such as for thermal fusion or binding of build material on the build platform to form the 3D object.

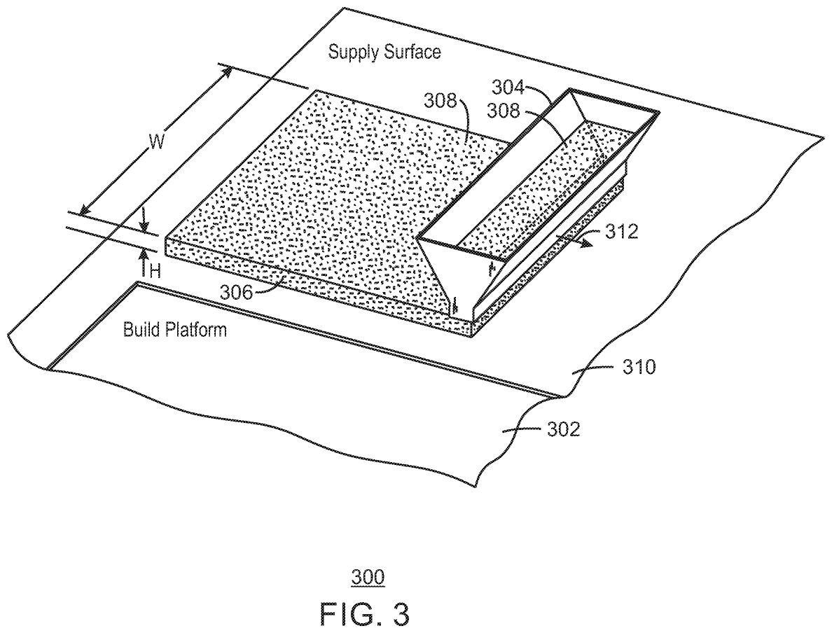

FIG. 3 is an internal region 300 of a 3D printer inside the housing of the 3D printer and having a build platform 302 on which the 3D printer forms a 3D object from build material. The 3D printer has a provision vessel 304 in the region 300. FIG. 3 depicts the provision vessel 304 dispensing a ribbon 306 of powdered build material 308 onto a supply surface 310 adjacent the build platform 302. In the illustrated example, the provision vessel 304 is moving in the direction of arrow 312 to dispense the ribbon 306 onto the supply surface 310. The 3D printer may have a movement device such as a carriage or other drive apparatus to operably move the provision vessel 304.

The relatively large surface area of the powder ribbon 306 compared to, for example, a pile of powder may facilitate quicker pre-heating of the build material 308 on the supply surface 310 before the 3D printer 300 spreads the ribbon 306 of build material over the build platform 302. The build material 308 in the ribbon 306, if heated, may be heated on the supply surface 310, for example, by conduction from below or by an energy source from above.

In one example of the build material 308 as polyamide powder, the average particle size is in the range of 35 microns (μm) to 45 microns, such as 40 microns. For that example, the minimum particle size may be about 4 microns and the maximum particle size about 110 microns. Further, the bulk density may be in the range of 0.3 gram/cc (g/cc) to 0.5 g/cc, such as 0.4 g/cc. In one example for the build material as stainless-steel powder, the average particle diameter may be in the range of 70 microns to 110 microns, and the angle of repose in the range of 20° to 50°, or 25° to 40°, and so forth.

In another example for the build material 308 as polyamide powder, the particle size distribution (PSD) may be substantially within the range of 5 microns to 200 microns, or 10 microns to 150 microns, and the average particle diameter in the range of 45 microns to 70 microns. In yet another example, the polyamide powder has a minimum particle size in the range of 3 microns to 12 microns, a maximum particle size in the range of 70 microns to 105 microns, and a mean particle size in the range of 25 microns to 55 microns.

In yet another example of polyamide powder, the PSD is D10 in the range of 20 microns to 35 microns, D50 in the range of 35 microns to 65 microns, and D90 in the range of 70 microns to 95 microns. With the sieve analysis for the PSD, the D10 is the particle diameter at which 10% of the sample mass is particles with a diameter less than the D10 value. The D50 is the particle diameter of the particle that 50% of the sample mass is particles with a diameter less than the D50 value. The D90 is the diameter of the particle that 90% of the sample mass is particles with a diameter less than the D90 value.

In yet another example for polyamide powder, the powder has a bulk density in the range of 0.35 g/cc to 0.55 g/cc, average particle size in the range of 40 microns to 70 microns, particle size range (D10 to D90) of 15 microns to 160 microns, or 10 microns to 200 microns, and so on. In general, angle of repose for an example polyamide powder is in the range of 20° to 45°, or 25° to 40°, or 23° to 35°, and the like. Polyamide powder with numerical values outside of the various aforementioned ranges for the powder characteristics may be employed as the build material 308. Moreover, powders other than polyamide or stainless steel may be utilized as the build material 308.

In some examples, the material provision vessel 304 as depicted may be, for example, a choke-flow dispenser. Moreover, for certain examples of the powdered build material as a plastic or polymer, such as polyamide or similar powder, the thickness or height H of the ribbon 306 may be, for instance, in the range of 0.8 millimeter (mm) to 2.0 mm. The width W of the ribbon 306 may be, for example, in the range of 30 mm to 80 mm. Thus, aspect ratios may be, for example, in the range of 15:1 to 100:1. However, dimensions and aspect ratios for the ribbon 306 outside these ranges may be implemented with the material provision vessels discussed herein. Also, powdered materials other than plastic or polymer may be employed as the build material 308. Moreover, these numerical ranges of dimensions may be applicable to a provision vessel 304 that dispenses, discharges, or releases build material 308 as a ribbon 306 but is not a choked-flow dispenser.

In operation, the desired amount of build material 308 in the ribbon 306 may be based on whether the particular 3D printer for the specific 3D object partially-covers or substantially fully covers the build platform 302 with each layer of build material. The amount of build material 308 in the ribbon 306 may be based on the dimensions of the build platform 302 that receives the ribbon 306 build material 308, and so on. For example, if build material 308 is to be layered to a thickness of 0.1 mm across a 300-mm build platform 302, then a supply ribbon 1-mm high and 30-mm wide, 0.8 mm high and 38-mm wide, or 0.6-mm high and 50-mm wide, may contain a volume of build material 308 just sufficient to cover the build platform 302 to the desired thickness. The operation may also dispense from the provision vessel 304 a volume of powder build material 308 into ribbon 306 that is more than enough to cover the build platform 302 to the desired thickness. Such may be implemented, for example, to account for variability in the density of the build material 308 or ribbon 306 and/or to account for irregularities in the surface of the build platform 302, and so forth. In addition to the desired volume, other factors may affect the aspect ratio of the powder supply ribbon 308. For one example, the type of heating system used may constrain the thickness (height H) of a supply ribbon 308 that can be pre-heated effectively on a build platform 302. For another example, the powder spreader or other layering system may impact the width of a supply ribbon that can be spread effectively over the build platform 302. The characteristics of the build material 308 powder itself may also affect the aspect ratio of the supply ribbon 306.

One or more baffles in the provision vessel 304 may provide for a more uniform ribbon 306 both in thickness and in density of the build material 308. Such may facilitate preheating of the ribbon 306, reduce waste of build material 308 in the application of the ribbon 306 to the build platform 302, and promote a more uniform or adequate amount of the subsequently applied layer of build material 308 across the build platform 302.

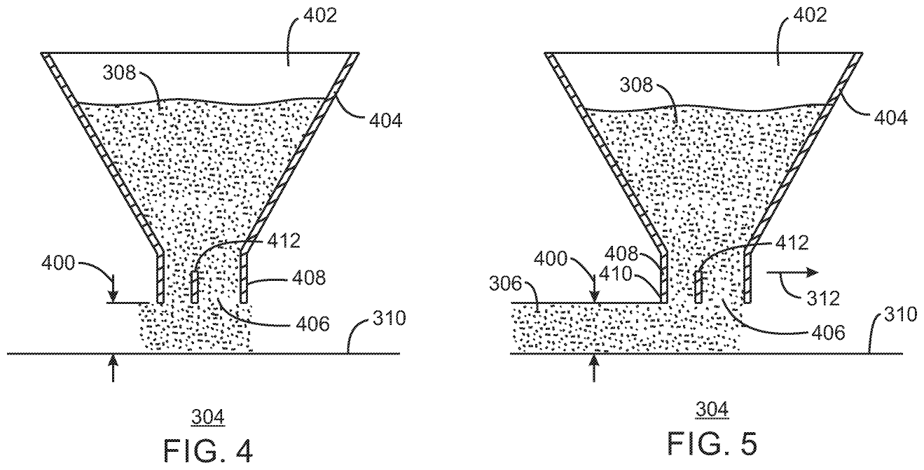

FIGS. 4 and 5 is a material provision vessel 304 depicted over a supply surface 310 for providing build material for a 3D printer to form a 3D object from the build material. The provision vessel 304 may be spaced apart from the supply surface 310 across a gap 400. In this example, provision vessel 304 is a hopper having a wall 404. The provision vessel 304 as a hopper includes a receptacle 402 to hold build material 308 and an elongated opening 406 oriented horizontally along a bottom portion 408 of the receptacle 402.

As shown in FIG. 5, a ribbon 306 of powdered build material 308 may be dispensed from the receptacle 402 through the opening 406 onto the supply surface 310 as the provision vessel 304 is moved over the supply surface 310. The opening 406 extends lengthwise in a direction perpendicular to the direction of motion of the provision vessel 304. The direction of motion of the provision vessel 304 is indicated by the arrow 312 in FIG. 5.

The gap 400 may be small enough to choke the flow of build material 308 from the provision vessel 304 when the provision vessel 304 is stationary over the supply surface 310. The gap 400 may be large enough to allow powder flow of the build material 308 when the provision vessel 304 is moving over the supply surface 310. In FIG. 4, the provision vessel 304 is stationary to choke (and thus block) the flow of powder build material 308 through the opening 406 across the gap 400. When the provision vessel 304 is stationary as shown in FIG. 4, the build material 308 may flow out of opening 406 until the build material 308 accumulating in the gap 402 meets the opening 406, at which point the flow may be choked to no additional flow. This choking condition may block the flow of the build material 308 until there is relative motion between the provision vessel 304 and the supply surface 310.

When the provision vessel 304 is moving, as shown in FIG. 5, the build material 318 is dragged from the opening 406 and flows into the gap 400 and onto the surface 310 until the provision vessel 304 stops. The bottom portion 408 of the provision vessel 304 may act as a metering blade 410 to layer the build material 308 onto the surface 310 in a ribbon 306. One side the hopper bottom portion 408 may serve as the metering blade 410. The particular side generally depends on the direction 312 of motion of the provision vessel 304. Thus, the left side in the illustrated example of FIG. 5 for motion 312 to the right. With the speed of the provision vessel 304 not exceeding the flow capacity of the opening 406, the thickness of ribbon 306 may be determined by the size of the gap 400 in some examples. Accordingly, the gap 400 can be set to the desired thickness for the ribbon 306.

While a stationary supply surface 310 and a movable provision vessel 304 are shown for dispensing the powder ribbon 306, the configuration and operation may instead be to dispense the ribbon 306 from a stationary provision vessel 304 onto a movable supply surface 310, or by moving both the supply surface 310 and the provision vessel 304 with respect to one another. Also, while the size of the gap 400 may be varied by moving one or both of the provision vessel 304 and the supply surface 310 vertically with respect to one another, an adjustable metering blade 410 may also be employed to vary the size of gap 400 in certain examples.

Lastly, the material provision vessel 304 includes one or more baffles 412 to inhibit or reduce flow of build material 308 out of the front portion (right side in the illustrated example) of the opening 406. As discussed below, such may reduce waste of the build material 308. The baffle 412 may encourage flow of build material 308 out of the back portion (left side in the illustrated example) of the opening 406. Moreover, the baffle 412 may promote a more uniform ribbon 306 both in terms of thickness and build-material 308 density.

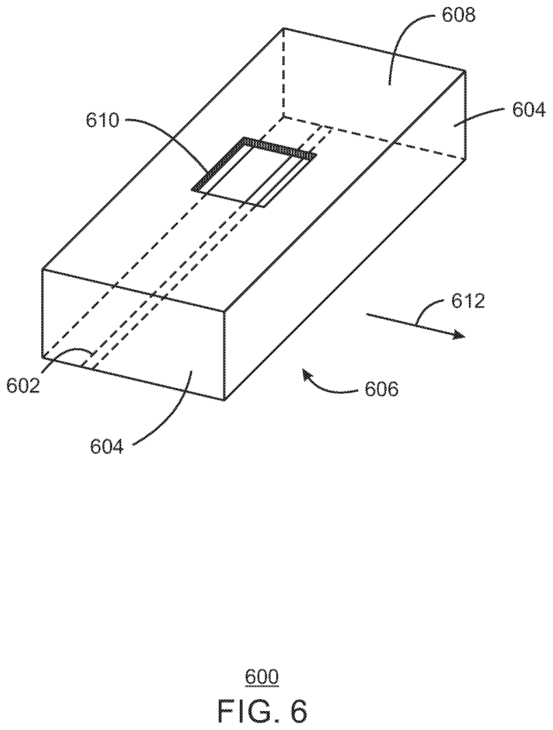

FIG. 6 is a material provision vessel 600 of a 3D printer to hold and dispense (or dose) build material for the 3D printer to generate a 3D object from the build material. The provision vessel 600 operates within the 3D printer. Indeed, the provision vessel 600 and, for example, the build enclosure of the 3D printer may both be within the outer housing or casing of the 3D printer.

The provision vessel 600 includes an internal baffle 602 to alter flow of build material discharging from the provision vessel 600. The provision vessel 600 may have more than one baffle 602. For instance, the provision vessel 600 can have at least five baffles 602. In one example with multiple baffles 602, the baffles 602 run or extend generally parallel with respect to each other along the length of the provision vessel 600.

The provision vessel 600 has external walls 604. The provision vessel 600 may receive and hold build material in the interior volume of the vessel 600 formed by the walls 604. In the illustrated example, the provision vessel 600 in a general sense is a rectangular prism in overall shape. One or more of the walls 604 may have an opening (not shown) to receive build material into the vessel 600 or to provide, for example, a window or view port to witness the powder-fill level in the provision vessel 600. Furthermore, the provision vessel 600 may have external coupling components including plates, flanges, bolts, holes, attach points, spring anchors, and so on, to secure the provision vessel 600 in the 3D printer.

The provision vessel 600 may have a top 608 resting on, coupled to, or formed with the walls 604. The top 608 may have an opening 610 for receiving build material. As indicated above for some examples, the material provision vessel 600 may receive build material from a dispense vessel such as a feed hopper. In certain examples, the build material may flow from the dispense vessel through one or more metering or dosing equipment to the material provision vessel 600. Such equipment may include a volume or apparatus to specify and regulate an amount of build material for the provision vessel. In addition, the metering equipment may include a feeder such as a rotary valve, screw feeder, auger, and the like. In a particular example, the dispense vessel or the intervening equipment may provide for a dosed amount in volume or weight of build material for the material provision vessel 600 to dose (e.g., as a ribbon) to a supply surface or dosing surface of the 3D printer for the build platform.

The provision vessel 600 has a bottom opening for a bottom exit 604 to dispense, discharge, or release build material, such as onto a supply surface of the 3D printer. The bottom opening exit 606 may be a partial opening or a substantially-full opening. In operation, the provision vessel 600 dispenses build material out the bottom exit 606. The provision vessel 600 may dispense the build material onto a supply surface (not shown) of the 3D printer as the provision vessel 600 moves across the supply surface. A build material applicator such as a powder spreader may distribute the dispensed build material from the supply surface to a build platform or other work deck for the 3D printer to form a 3D object from the build material.

In FIG. 6, the operational movement of the provision vessel 600 is in the direction of arrow 612. The front of the provision vessel 600 may be characterized as the side or wall 604 on the right in the lead with the movement 612. The back of the provision vessel 600 may be characterized as the side or the wall 604 to the left following the lead with the movement 612. The provision vessel 600 may discharge the build material to form a ribbon of build material on the supply surface. The ribbon may be formed to the left or behind the provision vessel 600 as the provision vessel 600 moves across the supply surface in the direction 612.

The baffle 602 may facilitate the discharge from a back portion or center portion of the exit 606 to form the ribbon on the supply surface. The baffle 602 may inhibit discharge of build material from a front portion of the exit 606 that does not become part of the ribbon. Thus, the baffle 602 may facilitate reducing the amount of build material that is loss or wasted, or subjected to recovery. The baffle 602 may alter the flow of the build material discharging through the exit 606 to provide for a ribbon that is more uniform in material density and more uniform in thickness. The baffle 602 may increase internal friction to alter the flow.

The baffle 602 is disposed in the inside volume of the provision vessel 600 within the walls 604. In some examples, the baffle 602 may run along a bottom portion of the vessel 600 including near or adjacent the exit 606. In certain examples, the baffle 602 does not extend outside of the provision vessel 600 or the exit 606. The baffle 602 is depicted as running the length of the provision vessel 600. The baffle(s) 602 may be inside the provision vessel 600 flush with the exit 606 inside away from the exit 606. However, other configurations of the baffle 602 are applicable.

Each end of the baffle 612 may be secured to an inside surface of the provision vessel 602, such as to an inside surface of a wall 604. For example, each end of the baffle 612 may couple to an inside surface via welding, bolting, or an adhesive, and the like. In another example, the baffle 612 is formed with the walls 608 in the molding (e.g., injection molding) of the provision vessel 600 if the provision vessel 600 is so formed. The baffle 612 may be 3D printed into the provision vessel 600. In particular examples, the baffle 612 may be removable or swappable. However, other implementations for securing the baffle 612 in provision vessel 600 may be employed.

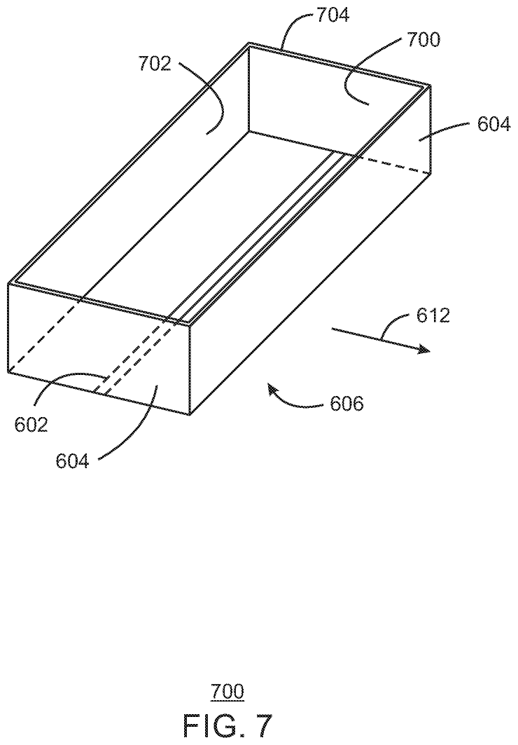

FIG. 7 is a provision vessel 600 of a 3D printer. The provision vessel 600 has walls 604 to form an inside region to receive and hold build material. The walls 604 have a wall thickness 704 such as between the outer surface of the wall and the inside surface of the wall. The provision vessel 600 has a bottom discharge-exit 606 to dispense build material.

As discussed, the provision vessel 600 dispenses build material onto a supply surface of the 3D printer as the provision vessel 600 moves across the supply surface, such as in the direction of arrow 612. The vessel 600 has a baffle 602 to alter discharge flow of build material.

In FIG. 7, the provision vessel 600 is depicted with no top (e.g., without the top 610 in FIG. 6). In one instance, the provision vessel 600 is installed in the 3D printer and operates in the 3D printer without a top. In another instance, the provision vessel 600 includes a top, such as the top 610 of FIG. 6, but the depiction of a top is omitted in FIG. 7 for clarity.

The baffle 602 may run along a bottom portion of the vessel 600 including near or adjacent the exit 606 without extending outside of the provision vessel 600 or the exit 606 in certain examples. As depicted in the illustrated example, each end of the baffle 612 is secured to a respective inside surface 708 of a short wall 604. The inside surface of a long walls 604 is denoted with the reference numeral 702. As mentioned, the material provision vessel 600 may have more than one baffle 612.

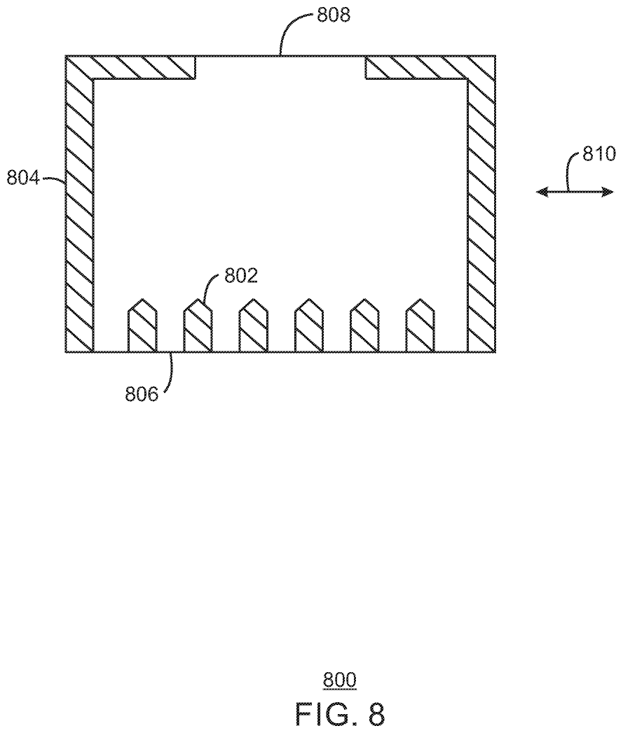

FIG. 8 is a side cross-section view of a material provision vessel 800 of a 3D printer. The vessel 800 has multiple baffles 802 inside the walls 804 of the vessel 800. The baffles 802 extend lengthwise in the vessel 800 and are disposed along the material exit 806 of the vessel 800. Further, the provision vessel 800 has an opening 804, such as a powder-fill orifice, at the top to receive build material in this example. The provision vessel 800 may also have, for instance, an air vent such as on an upper portion of the vessel 800. The provision vessel 800 may also have coupling elements or attachment features such as on an external surface (e.g., on a side of the provision vessel 800) to facilitate installation of the provision vessel 800 within the 3D printer. Moreover, the provision vessel 800 may have powder directors (e.g., blades, ridges, plates, edges, etc.) on a lower portion of an external surface of a wall 804 such as at a corner(s) of the exit 806. The powder directors may maintain or keep the discharging build material where desired. Lastly, the provision vessel 800 may include “skis” (e.g., a zig-sag of skis) along the exit 808. The skis may be sliding surfaces with powder directors to advance discharge of the build material.

In operation to discharge build material, such as onto a supply surface of the 3D printer, the provision vessel 800 may move to the left or right, as indicated by reference numeral 810 and depending on, for example, the installation. The baffles 802 alter the discharge flow of build material from the provision vessel 800 through the material exit 806.

In the illustrated example, the baffles 802 have a vertical or normal orientation. In other words, the baffle 802 height is generally parallel to flow of build material, whereas the baffle 802 width is generally perpendicular to flow of build material. Thus, again, the baffles 802 may be characterized as having a normal vertical orientation. Moreover, the baffles 802 have a triangular prism portion or peak on their upper surface. In other examples, the upper surface is flat or has a geometry different than a peak.

In examples, the baffles 802 may reduce discharge of material from a front portion of the exit 806 of the provision vessel 800 as the provision vessel moves 800 across the supply surface, including when the provision vessel 800 starts or stops moving. The reduction is discharge flow rate (e.g., volume or mass) may be due at least in part to the internal friction on the flowing build material caused by the baffles 802.

The baffles 802 may promote the desired discharge of build material from a back portion of the exit 806 of the provision vessel 800. The shape of the baffles, and their impact of the discharge flow of build material may be influenced by internal friction, pressure head of the build material in the provision vessel 800, and external friction at the exit 806, and so on. The baffles 802 can also have an angled orientation or other configurations, as discussed below.

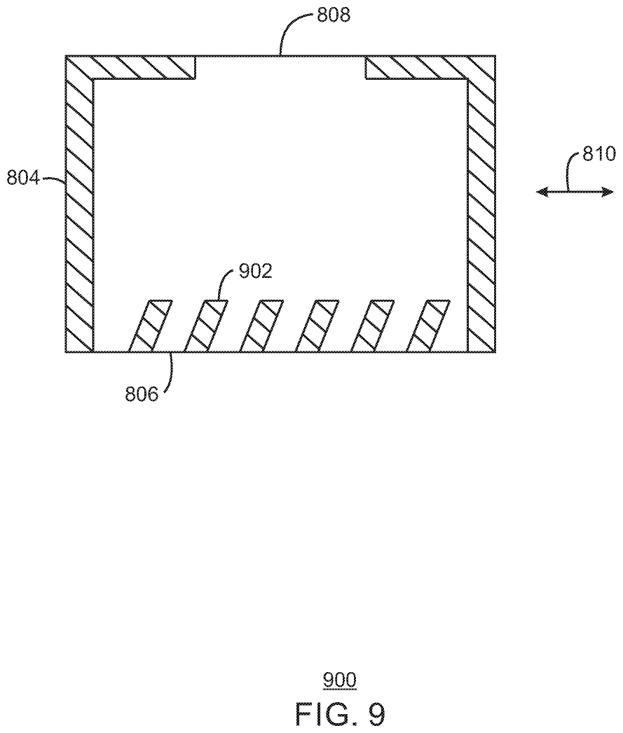

FIG. 9 is a side cross-section view of a material provision vessel 900 of a 3D printer. The vessel 900 is similar to the provision vessel 800 of FIG. 8. The vessel 900 has internal baffles 902 that may be different in shape and orientation than the internal baffles 802 of FIG. 8. In the illustrated example, the baffles 902 have an angled orientation. Indeed, the baffles 902 have an angled vertical orientation in contrast to the normal vertical orientation of the baffles 802 in FIG. 8. Moreover, the example baffles 902 have a generally flat upper surface.

Again, the multiple baffles 802 or 902 may have a length generally corresponding to the length or radius of the discharge port or exit 206 of the provision vessel 900. On the other hand, the ends of the baffles 802 or 902 may not extend completely between the walls 604, and may be secured to, for example, to the top, other walls, or coupling elements within the provision vessel 800 or 900. Moreover, the baffles 802 or 902 may not extend continuously but intermittently in pieces.

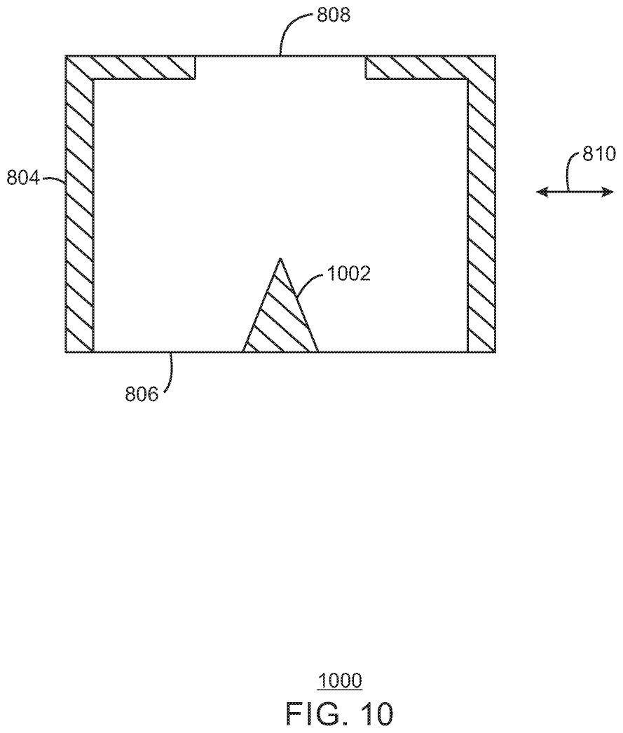

FIG. 10 is a side cross-section view of a material provision vessel 1000 of a 3D printer. The vessel 1000 is similar to the provision vessels 800, 900 of FIGS. 8 and 9, except that a single baffle 1002 is employed. In particular, the vessel 1000 has an internal baffle 1000 disposed generally in a central region of the exit 806. The single baffle 1000 may extend lengthwise and generally continuously along the length of the provision vessel 1000, or partially or intermittently. In one example, the baffle 1002 has a triangular prism shape and is a single baffle disposed in a central region of the exit 806 forming two zones of the exit 806 on each side of the baffle 1002.

The number, size, shape, length, width, height, and the like, of the baffles discussed herein may be determined in view of different factors and techniques. The specified number, size, shape, and placement of the baffles may be to promote a uniform ribbon of build material in thickness and density on the receiving supply surface, and to reduce waste of build material, and so forth. The number, size, shape, and placement of the aforementioned baffles which may be internal or partially-internal in the provision vessels discussed with respect to the preceding figures may specified per hydraulic calculations, computer powder-flow modeling, empirical testing, and so on. Process variables such as internal friction, external friction, and the head pressure of the level of build material in the provision vessel, and other parameters may be considered.

As mentioned, the build material may be powder. As used herein, the term “powder” as build material can, for example, refer to a powdered, or powder-like, material which may be layered and sintered, melted, or fused during a print job of 3D printing. The powdered material can be, for example, a powdered semi-crystalline thermoplastic material, a powdered metal material, a powdered plastic material, a powdered composite material, a powdered ceramic material, a powdered glass material, a powdered resin material, or a powdered polymer material, among other types of powdered material.

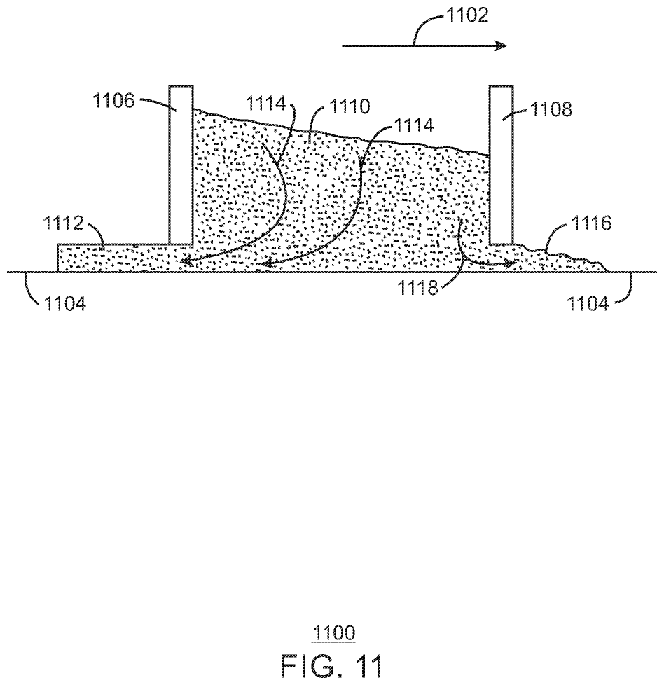

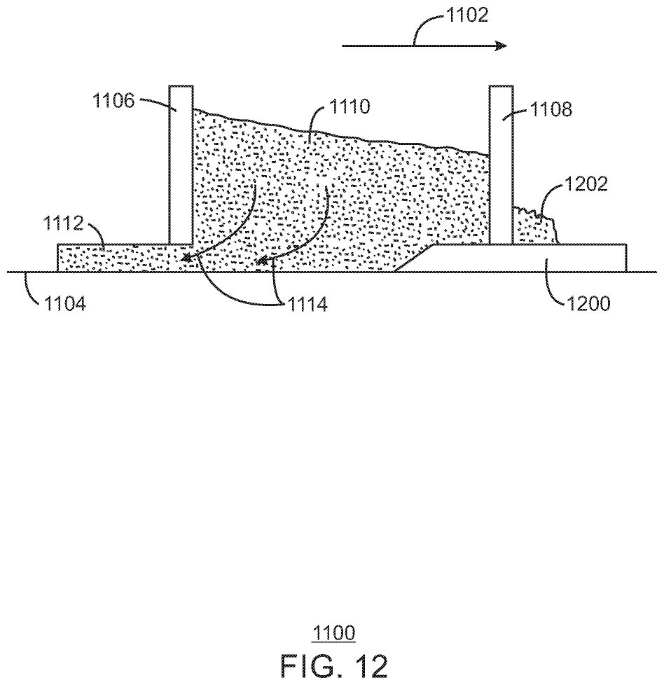

FIGS. 11 and FIG. 12 are a provision vessel 1100 of a 3D printer moving in direction 1102 over a supply surface 1104 of the 3D printer. The depiction is simplified for clarity showing the walls 1106 and 1108 of the provision vessel 1100. In view of the direction 1102 of movement, the left wall 1106 may be labeled as the back wall and the right wall 1108 may be labeled as the front wall.

The provision vessel 1100 has an inner volume or inside region at least partially defined by the walls 1106, 1108 and having build material 1110 operationally disposed or held therein. The provision vessel 1100 releases or discharges the build material 1110 out through a central or rear portion of a bottom exit to form a ribbon 1112 of build material 1110 on the supply surface 1104. This flow of build material 1110 inside the provision vessel 1100 to dispense build material 1110 under the back wall 1106 is indicated by arrows 1114.

In this example, the provision vessel 1100 does not have a baffle or does not have sufficient baffling. Therefore, in some cases, a relatively significant amount of build material 1110 discharges through a front portion of the bottom exit under the front wall 1108. Thus, as shown in FIG. 11, a pile 1116 of build material may collect and form on the supply surface 1104 in front of the moving provision vessel 1100.

This flow of build material 1110 inside the provision vessel 1100 that discharges build material 1110 under the front wall 1108 is indicated by arrow 1118. In the absence of baffling in the provision vessel 1110, this free flow of powder which can be fluid-like may readily progress undesirably from the front portion of the bottom exit under the front wall 1108.

FIG. 12 depicts the provision vessel 1110 nearing completion of discharging the ribbon 1112 of build material 1110 onto the supply surface 1104, as indicated with the provision vessel 1100 approaching the ridge 1200. The ridge 1200 is at the conclusion of the supply surface 1104 such that as the provision vessel 1100 passes over the ridge 1200, the discharge of build material 1110 from the provision vessel 1100 is stopped. In other words, the ridge 1200 has a height generally equal to the gap between the provision vessel 1100 and the supply surface 1104. Therefore, the provision vessel 1100 interfacing with the ridge 1200 fills or obstructs the gap with the ridge 1200 and stops the discharge of build material from the provision vessel 1100. The ridge 1200 may be a plate or other solid component and generally shaped to fit into the gap between the provision vessel 1100 and the supply surface 1104. The facing slanted portion or surface may be characterized as the transition region of the ridge 1200.

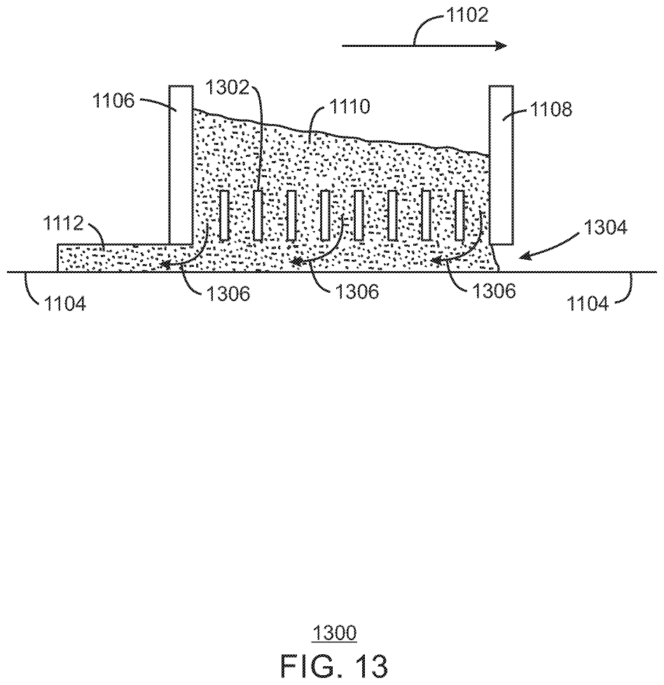

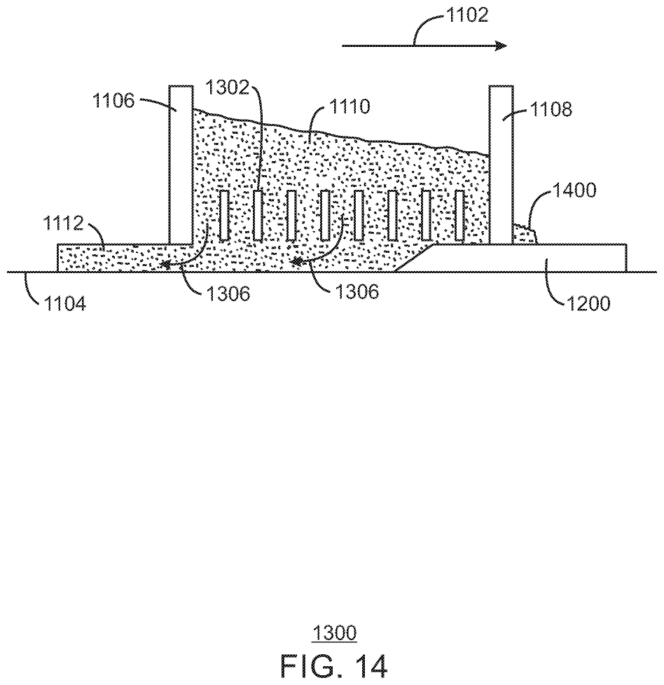

The pile 1116 of build material 1110 depicted in FIG. 11 results in the excess build material 1202 on the ridge 1200 in front of the provision vessel 1100 in FIG. 12. The excess build material 1202 may be characterized as wasted in that the excess material 1202 is not formed in the ribbon 1112 pushed and spread to the build platform. Again, the 3D printer forms a 3D object from build material on the build platform. As described above, the pile 1116 is formed due to the discharge of build material 1100 from the front portion of the provision vessel as indicated by arrow 1118 in FIG. 11. As discussed below with respect to FIG. 13 and FIG. 14, the presence of baffling may restrain the discharge of build material 1110 from the front portion of the provision vessel 1108.

FIG. 13 and FIG. 14 are a provision vessel 1300 having baffles 1302. As with the provision vessel 1100, the provision vessel 1300 is depicted moving in direction 1102 over the supply surface 1104. The provision vessel 1300 may be similar to the provision vessel 1100, except for the inclusion of the baffles 1302. The baffles 302 may allow or promote flow of build material, as noted by arrows 1306, toward and out the back portion of the provision vessel 1100 to form the ribbon 1112 of build material 1110. The baffles 302 may impact or alter the flow of build material such that the discharge of build material from the front portion 1304 of the provision vessel 1100 is restrained or inhibited. Therefore, as depicted in FIG. 14, little or no excess build material 1400 may accumulate in front of the provision vessel 1300 such as on the ridge 1200.

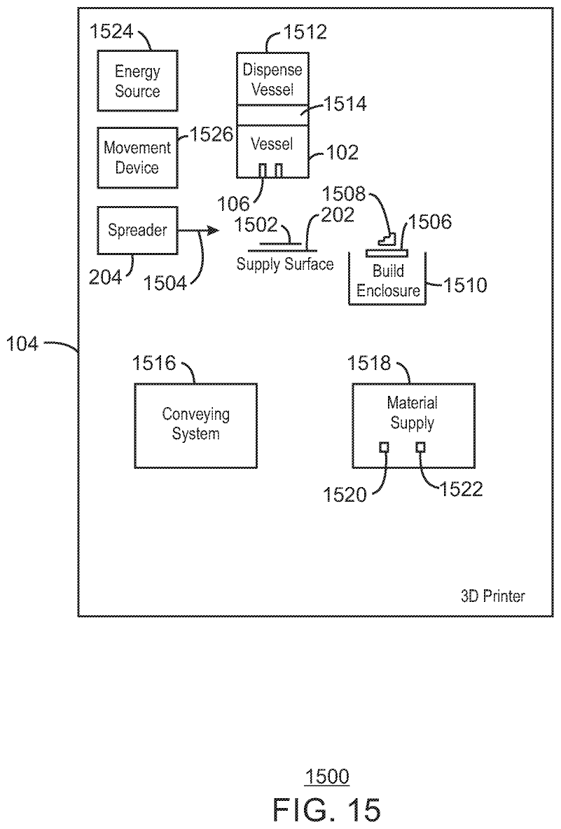

FIG. 15 is a 3D printer 1500 having a material provision vessel 102 disposed within a housing 104 of the printer 1500. In some examples, the material provision vessel 102 may be a hopper, provision hopper, container, provision container, dosing vessel, dosing hopper, dosing container, dosing box, and the like. The provision vessel 102 has one or more internal baffles 106 to alter internal flow of build material with the vessel 102 and to alter the discharge or discharge flow of build material from the provision vessel 102.

The 3D printer 1500 may sinter, melt, or fuse build material to form a 3D object. For example, the 3D printer 1500 may employ SLS, SHS, EBM, thermal fusion, or other AM technique to print or generate a 3D object. The build material may be made from one or more of metal, plastic, polymer, glass, ceramic, or other material. The provision vessel 102 may hold and discharge build material for the generation of the 3D object.

In operation, the provision vessel 102 moves over a supply surface 202 to discharge a ribbon 1502 of build material onto the supply surface 202 of the 3D printer 1500. A build-material applicator, such as a powder spreader 204, may move as indicated by arrow 1504 across the supply surface 202 to displace and spread the ribbon 1502 of build material to across the build platform 1506. Such provisioning of build material to the supply surface 202 and spreading of build material from the supply surface 202 to across the build platform 1506 may be repeated for each layer of build material on the build platform 1506 in the forming of the 3D object 1508.

The supply surface 202 may be a dosing surface, a supply deck, a source platform, and the like. The build-material applicator or powder spreader 204 may include a mechanical arm, a roller, or other feature to push or pull the ribbon 1502 of build material to the build platform 1506. The 3D printer 1500 may form the 3D object 1508 layer-by-layer from successive layers of build material on the build platform 1506.

In examples, the build platform 1506, which receives build material to form the 3D object 1508, may reside on a piston or other elevating apparatus. The 3D printer 1500, including a computing system or controller, may lower the build platform 1506 incrementally as each layer of the 3D object 1508 is formed. For example, each increment (e.g., 60 microns, 80 microns, 100 microns, etc.) may be in the range of 50 microns to 150 microns as the height amount in which the build platform 1508 is lowered for each layer of build material and for the associated formed layer of the 3D object 1508. The increment amount may be less than 50 microns or greater than 150 microns. As depicted, the 3D object 1508 may be formed within the outer housing or housing 104 of the 3D printer 1500.

In one example, the build platform 1506 is removable and the 3D printer 1500 may be manufactured and sold without the build platform inserted in the 3D printer. The 3D printer 1500 may include a build enclosure 1510 associated with the build platform 1506. The build enclosure 1510 may be a build bucket, build chamber, build container, build housing, and the like. In some examples, the build enclosure 1510 may at least partially contain the build platform 1506. Moreover, the build enclosure 1510 and the build platform 1506 may be components of a build unit of the printer 1500. In particular examples, the build unit may be a fixed unit and not operationally removable from the 3D printer 1500. In other examples, the build unit is not intended to be operationally removable. Moreover, the printer 1500 may also include a build unit processing module to separate printed objects from unfused material. In addition, the 3D printer 1500 may include a 3D printed object recovery zone from which separated 3D objects may be recovered after unfused material extraction.

The material provision vessel 102 may receive build material from a dispense vessel 1512 such as a feed hopper. In some examples, the build material may flow from the dispense vessel 1512 through a metering component(s) 1514 to the material provision vessel 102. The metering component(s) 1514 may include a feeder such as a rotary valve, screw feeder, auger, and the like. In addition, the metering component(s) 1514 may include a volume or apparatus to specify and regulate and amount of build material for the provision vessel 102. In certain examples, the metering component(s) 1514 may provide for a dosed amount in volume or weight of build material for the material provision vessel 102 to dose as the ribbon 1502 to the supply surface 202.

The 3D printer 1500 may include a conveying system 1516 and a material supply system 1518 to provide build material to the dispense vessel 1512 for the provision vessel 102. The conveying system 1516 may transport build material to the dispense vessel 1512 from the material supply system 1518. The conveying system 1516 may be an internal conveying system 1516 within the housing 104. The 3D printer 1500 may also include additional internal conveying systems, such as a vacuum system for recovering excess or unused build material from the build enclosure 1510.

The conveying system 1516 for supplying build material from the material supply system 1518 to the dispense vessel 1512 may be a pneumatic conveying system, a mechanical conveying system, a screw or auger feeding system, vibrational conveying system, a belt conveying system, or any combinations thereof. Portions of the conveying system 1516 may rely on gravity.

If pneumatic conveying is employed, the conveying system 1516 generally include conduits, fittings, and valves to transport the build material. The pneumatic conveyance system may be dilute phase or dense phase. If dilute phase is employed, the pneumatic conveyance system may be negative-pressure system or a positive-pressure system. The pneumatic conveyance system may include a motive component, such as a blower, to provide a motive force for conveying air through the transport conduits.

Lastly, the pneumatic conveying system, if employed as the conveying system 1516, can include separators, such as cyclone, filters, and the like, to separate build material or other solids from conveying air. For example, a cyclone or centrifugal separator may be disposed above the dispense vessel 1512 to separate conveying air from the build material, and discharge the build material (e.g., minus conveying air) to the dispense vessel 1512. Again, in examples, a pneumatic conveying system 1516 may be inside the housing 104 and not an external system.

The material supply system 1518 may also be internal within the housing 104 of the 3D printer 1500. The supply system 1518 may include a cartridge receiver 1520 to hold a material cartridge. For example, a user may insert a material cartridge into the cartridge receiver 1520. The material cartridge may be a container, canister, or cylinder having build material. The cartridge receiver 1520 may be a receptacle, slot, cavity, or the like. The printer 1500 may make available build material from the material cartridge held in the cartridge receiver 1520 of the 3D printer 1500. The conveying system 1516 may receive build material from the material cartridge. Moreover, in some examples, an empty or partially-empty material cartridge inserted into the cartridge receiver 1520 may receive excess build material from the 3D printing as recycle build material. Lastly, the material supply system 1518 may include more than one cartridge receiver 1520.

In certain examples, the material supply system 1518 may include a material vessel 1522, such as a hopper, to hold build material and make available build material for the 3D printing. For example, the material vessel 1522 may discharge build material to the conveying system 1516, such as through a feeder to the conveying system 1516. In one example of the conveying system 1516 as a pneumatic conveyance system, the material vessel 1522 may discharge build material through a feeder to a conduit of the conveying system 1516. The material vessel 1522 may receive build material from the material cartridge inserted into the cartridge receiver 1520. In certain examples, the material vessel 1522 may receive excess or unfused build material from the 3D printing, such as from the build enclosure 1510. The printer 1500 may have more than one material vessel 1522. Lastly, in examples, the material vessel 1522 may be operationally removable.

The 3D printer 1500 may include an energy source 1524 to apply energy to build material on the build platform 1506 to form a 3D object from the build material. The energy source 1524 may be a laser source for SLS, an electron beam source for EBM, a thermal printhead for SHS, a heat source or light source for thermal fusion, and so on. The 3D printer 1500 under computer control may sinter, melt, or fuse selected portions of successive layers of build material on the build platform 1506 to solidify those selected portions to form the 3D object 1508 layer-by-layer. The computer control and the portions selected on each successive layer of build material on the build platform 1506 may be per a 3D model or other electronic data source.

The 3D printer 1500 may include a movement device 1526, such as carriage or other drive system, to move or position the energy source 1524 over the build material on the build platform 1506. Indeed, the energy source 1524 may reside on the movement device 1526. The movement device 1526 may include or be associated with a motor, belts, rails, wheels, etc. to provide for movement and positioning of the movement device 1526. In certain examples, the movement device 1526 may have a rest position away from the build platform 1506.

The powder spreader 204 may also reside on the movement device 1526. The powder spreader 204 may share the movement device 1526 with the energy source 1524 or instead have a separate dedicated movement device 1526. Indeed, the printer 1500 may have more than one movement device 1526. The powder spreader 204 and the energy source 1524 may reside on a movement device 1526, such as on a support, platform, or frame of the movement device. A movement device 1524 may have a frame to hold and support the powder spreader 204 and/or the energy source 1524.

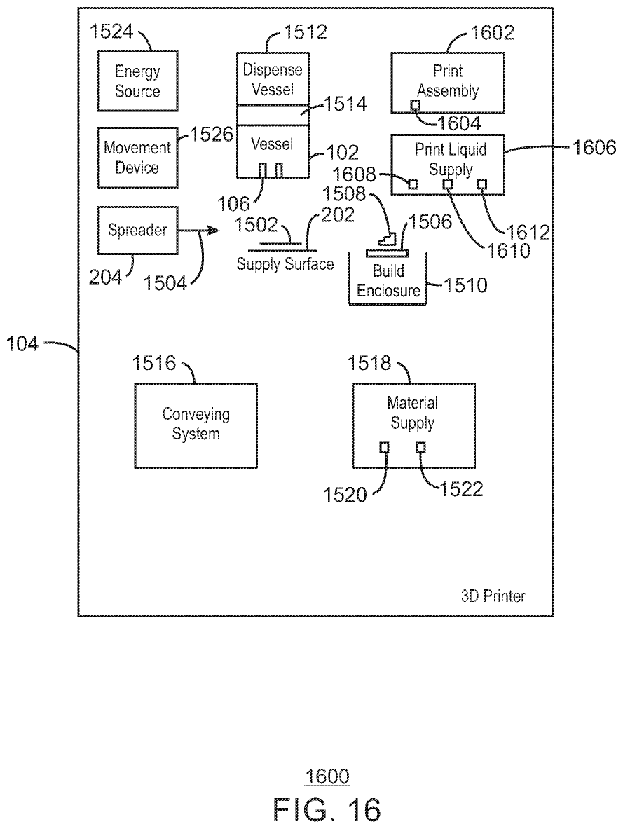

FIG. 16 is a 3D printer 1600 similar to the printer 1500 of FIG. 15 but having a print assembly 1602 for ejecting print liquid onto the build material on the build platform 1506. For instances of the 3D printer 300 employing print liquid in the solidification of build material into the 3D object. The solidification may involve fusion, binding, curing, and so on, of the build material on the build platform 1506. For example, the fusion may be thermal fusion with the print liquid as a fusing agent or other printing agent. For thermal fusion, the build material may be different materials including polymers, plastics, metals, ceramics, and so on. In one example with thermal fusion, the build material includes polyamide or Nylon. In some examples, the fusing agent accelerates or increases the absorption of energy from an energy source into the build material. In other examples, the fusing agent may react with the build material. As for binding of build material to form the 3D object, the build material may include, for example, gypsum powder, calcium sulfate dihydrate, or similar materials. Thus, the print liquid may include, for instance, a printing agent to bind the gypsum powder or similar powder to generate the 3D object on the build platform. Examples of curing as the solidification may include, for example, UV curing of selected portions of each layer of the build material applied to the build platform.

In all, the 3D printer 1600 may sinter, melt, fuse, bind, or cure build material to form the 3D object 1508. For each successive layer of build material, the print assembly 1602 may eject print liquid onto selected portions of the build material. The print liquid may include a fusing agent, a curing agent, a binding agent, a detailing agent, a coloring agent, a fusing coloring agent, or any combinations thereof. In some examples, the print assembly 1602 may reside on or interface with one of the movement devices 1526. Indeed, in certain examples, a movement device 1526 under computer control may position the print assembly 1602 over the build material on the build platform 1506, such that, for instance, the print assembly 1602 can eject print liquid onto selected portions of each successive layer of build material on the build platform 1506.

The print assembly 1602 may include nozzles 1604 to eject the print liquid. The print assembly 1602 may include a printbar or printheads, or other type of print assembly. The print assembly may be a printbar having the print nozzles 1604 to eject the print liquid. The nozzles 1604 may be disposed on dies or printheads, or on other substructures, of the printbar. The number of print nozzles 1604 can be up to hundreds or thousands, or more. The diameter of each nozzle 1604 can be in the tens or hundreds of microns. The ejection of the print liquid through the nozzles 204 may be via pressure differential, a pump, thermal or heat, heating elements, thermal bubble or bubble jet, piezoelectric, and so on. As mentioned, the print assembly 202 may eject print liquid onto successive layers of build material applied to the build platform 1506. The print assembly 1602 may eject the print liquid onto selected portions of each layer of the build material under computer control to generate respective layers of the 3D object being formed. The computer control may be per a model, e.g., 3D model, of the 3D object to be generated.

The 3D printer 200 includes an energy source 1524 to apply energy to the build material on the build platform to form the 3D object from the build material. The presence of the print liquid ejected onto the selected portions of the build material may increase energy transfer into those portions of the build material such that those portions of build material are selectively solidified or fused. The energy source 1524 may include a light source, infrared light source, near-infrared light source, radiation source, heat source, heat lamps, ultraviolet (UV) light source, and so on. The energy source 1524 in conjunction with the print assembly 1602 may print the 3D object 1508 layer-by-layer from build material on the build platform 1506.

In summary for some examples, the 3D printer 1600 forms the 3D object 1508 layer-by-layer via thermal fusion of the build material on the build platform 1506. In one example, the build material is a plastic or polymer, such as polyamide. In that example, the formed 3D object 1508 may be a prototype, or a product or product component. In another example, the build material is metal, such as stainless steel. In that example, the formed 3D object 1508 may be a prototype, or a machine part or other metal component that may also be formed, for example, by injection molding. Many other examples are applicable.

As indicated, the print liquid may be printing agents such as fusing agents to promote thermal fusion, detailing agents (e.g., water, etc.) to inhibit fusion, coloring agents, and other compounds. In operation, a print-liquid supply system 1606 may receive print liquid from the print liquid cartridge held within the printer 1600. The 3D printer 1600 may include an internal print-liquid supply system 1606 to provide print liquid to the print assembly 1602. Again, the print liquid may include printing agents or other compounds. In certain examples, the print-liquid supply system 1606 may include at least one pump 1608 to provide a motive force for supply of the print liquid to the print assembly 1602. In other examples, a pump 1608 is not employed but instead gravity or other motive force is employed to deliver print liquid to the print assembly 1602.

The print-liquid supply system 1606 may include at least one liquid cartridge receiver 1610 to hold an operationally-removable print-liquid cartridge. The print liquid cartridge may be a container that stores print liquid and is inserted by a user into the liquid cartridge receiver 1610. The liquid cartridge receiver 1610 may be a slot, receptacle, or cavity to receive and secure the print liquid cartridge. The print-liquid supply system 1606 may have multiple liquid-cartridge receivers 1610, such as for respective different print liquids or redundant same print liquids.

In operation, the print-liquid supply system 1606 may receive print liquid from the print liquid cartridge held by the liquid cartridge receiver 1610. Again, the supply system 1606 may deliver the print liquid to the print assembly 1602. Lastly, the print-liquid supply system 1606 may include a reservoir vessel 1612 to hold and facilitate delivery of print liquid. The supply system 1606 may include multiple reservoir vessels 1612. The supply system 1606 may employ a reservoir vessel 1612 in conjunction with a pump 1610 to facilitate delivery of print liquid to the print assembly 1602.

The printer 1600 may include the print assembly 1602 to eject print liquid onto selected portions of the build material on the build platform 1506 to form the 3D object 1508 layer-by-layer from the build material. The print assembly 1602 may apply print liquid to selected portions of layers of build material applied to the build platform to form associated layers of the 3D object. The print assembly 1602 may eject print liquid onto selected portions of successive applications or layers of build material on the build platform to form successive layers of the 3D object. In operation, the 3D printer 1600 may lower the build platform incrementally as each layer of the 3D object is formed. As indicated, the print liquid may include fusing agent, detailing agent, coloring agent, colorant, pigment, carrier, dye, thermoplastic, binding agent, curing agent, and so on.

The printer 1600 has the internal provision vessel 102 with one or more baffles 106 disposed at least partially inside the vessel 102 to alter flow of build material from the provision vessel 102. The provision vessel 102 may hold and discharge build material for the generation of the 3D object 1508. In operation, the provision vessel 102 may move over a supply surface 202 to discharge a ribbon 1502 of build material onto the supply surface 202 of the 3D printer 1500. A powder spreader 204 may move across the supply surface 202 to displace and spread the ribbon 1502 of build material to across the build platform 1506. The material provision vessel 102 may be employed in the 3D printer 1500 or other 3D printers that employ layers of build material to form a 3D object.

As discussed, the 3D printer 1600 may also have a build enclosure 1510 which may at least partially contain or otherwise be associated with the build platform 1506 on which the 3D printer 1600 forms the 3D object 1508. Moreover, the build enclosure 1510 and the associated build platform 1506 together may constitute a build unit. In certain examples, the build unit may be operationally removable. Indeed, while FIG. 16 depicts a build platform 1506, the printer 1600 may be manufactured and sold without the build platform 1506 (or the build enclosure 1510) in examples with a removable build unit. In other examples, the build unit is not operationally removable.

Furthermore, a build unit processing module may include or involve a build unit including the build enclosure 1510 and the build platform 1506. The build platform 1506 may have holes to allow unsolidified powder to flow through the build platform 1506. In addition, the build unit processing module may include sieves, vibration sources such as a motor with an eccentric or off-center mass, air flow devices, and other components to remove excess build material, e.g., unsolidified powder, from the build platform 1506. The 3D object 1508 disposed on the build platform 1506 may cool at an accelerated rate after the excess material or powder is removed from the build enclosure 1510. In other words, the 3D object 1508 may cool faster with surrounding excess build material removed. In this fashion, the build unit processing module may manage the cooling process, e.g., by removing the excess build material. The build unit processing module may provide for discharge of excess material from the build enclosure 1510.

At the conclusion of a print job and after most or all of the excess or unsolidified material or powder is removed from the build enclosure 1510, the build enclosure 1510 may include a 3D object 1508 with partially-solidified powder caked on the outside of the 3D object 1508. In certain examples, this partially-solidified powder may be removed by a bead blaster, a brush, or other tools that may be part of the build unit processing module. Partially-solidified powder may be removed from the build enclosure 1510. Partially-solidified powder may be removed from the 3D object 1508 in the build enclosure 1510 or after the 3D object 1508 has been removed from the build enclosure 1510.

Furthermore, in some examples, the printer 1600 may have a 3D-printed-object recovery zone. Indeed, once some or most of the unsolidified powder has been removed from the 3D object 1508 (and from the build enclosure 1510), the 3D object 1508 may be recovered via the 3D-printed-object recovery zone in those examples. In operation, the build platform 1506 may be manually or automatically lifted, e.g., via an underlying piston, towards the top of the build enclosure 1510 to the recovery zone so that a user may recover the 3D object 1508. In an example, this 3D-printed-object recovery zone may be accessed by a user or machine through a top or side opening of the 3D printer 1600. The opening may be through an outer housing or casing of the 3D printer 1600. In some examples, the zone may be accessed by lifting a lid or a removable top of the 3D printer 1600. In other examples, a door(s) of the 3D printer may be opened to access the zone.

The recovery zone may include tools to remove any remaining free build material or powder from the 3D object 1508 and to clean the build platform 1506. The 3D-printed-object recovery zone may also include containers to store printed 3D objects, a light source to illuminate the zone, and devices to provide air flow to prevent or reduce excess build material from exiting the 3D printer 1600 during recovery of the printed 3D object, and so on.

Lastly, while various examples and printer components have been discussed, it should be emphasized that the material provision vessel 102 having the baffle(s) 106 may be applicable generally to any 3D printer utilizing a ribbon or layer of build material and in which uniformity in thickness and/or density is desirable. In some examples, a 3D printer may employ the material provision vessel 102 to apply a layer of build material to a build platform. The provision vessel 102 may apply the build material directly to the build platform or other work area in which the 3D object is formed. In other examples, the provision vessel 102 may apply build material to a supply surface, such as a dosing surface or supply deck, to make available build material for the build platform. Other installations of the material provision vessel 102 in a 3D printer may be implemented.

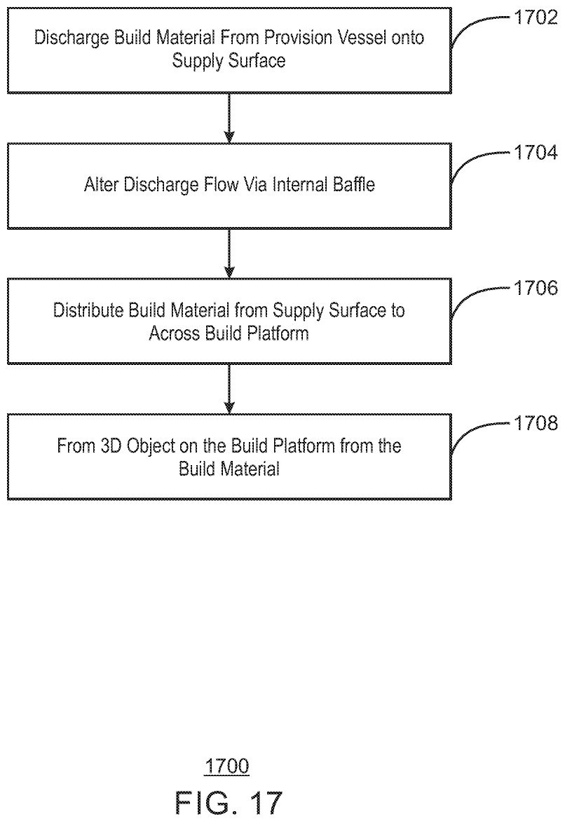

FIG. 17 is a method 1700 of operating a 3D printer having a material provision vessel with an internal baffle. In certain examples, the internal baffle may be coupled to an inside surface of the provision vessel. Moreover, the internal baffle may reduce a cross-sectional area of an exit of the material provision vessel, the exit for the discharging of the build material. In a particular example, the internal baffle does not extend outside the provision vessel. Lastly, the provision vessel may have more than one internal baffle.

At block 1702, the method includes discharging build material from the provision vessel as a ribbon of build material onto a supply surface of the 3D printer. The method may include moving the provision vessel across the supply surface to discharge the build material as the ribbon. At block 1704, the method includes altering, via an internal baffle in the provision vessel, flow of build material discharging from the provision vessel onto the supply surface to promote uniformity of thickness of the ribbon. The altering of the flow may also advance uniformity of build-material density through the ribbon.

The altering flow via the internal baffle may reduce discharge of the build material from a front portion of the provision vessel. The altering of the flow may also promote discharge of build material from a back portion of the material provision vessel. The altering of flow via the internal baffle may increase internal friction in the provision vessel reducing discharge flow of the build material from the provision vessel.

At block 1706, the method includes distributing, via a powder spreader, build material from the supply surface to across a build platform. For example, a movement device, such as a carriage, may move the powder spreader across the supply surface to displace the ribbon of build material from the supply surface to the build platform as a layer of build material on the build platform. The powder spreader may include a roller or mechanical arm, or the like, to push, pull, or otherwise disperse the build from the supply surface to across the upper surface of the build platform.

Lastly, at block 1708, the method includes forming a 3D object from the build material on the build platform. For example, the 3D printer may sinter, melt, fuse, bind, or cure selected portions of successive layers of build material on the build platform to form the 3D object layer-by-layer. The position of the selected portions may be per, for example, a 3D model implemented under computer control. Moreover, in some examples, the 3D printer may incrementally lower the build platform as each layer of the 3D object is formed.

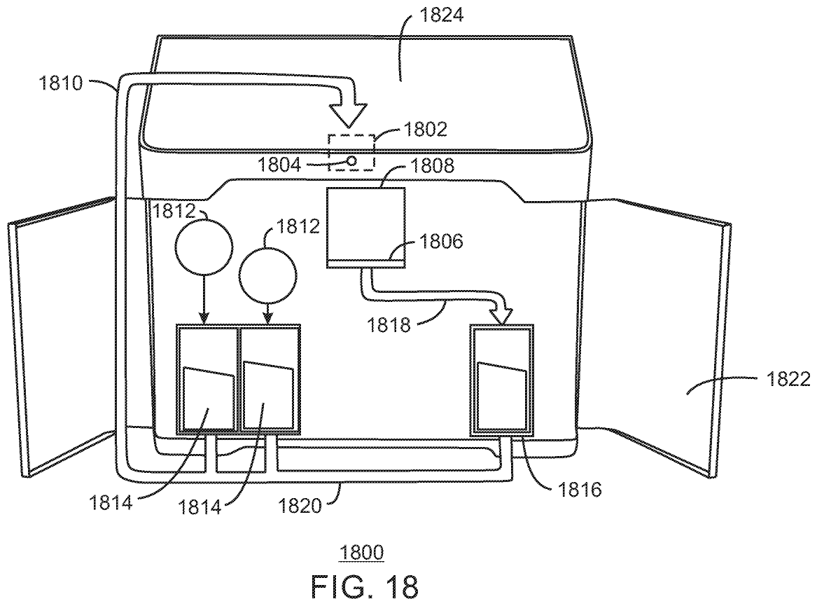

FIG. 18 is a 3D printer 1800 having a material provision vessel 1802 internally within the printer 1800. In the illustrated example, the provision vessel 1802 is disposed in an upper portion of the printer 1800. The provision vessel 1802 provides, doses, or meters build material for the 3D printer to generate a 3D object from the build material. In some examples, the provision vessel 1802 may lay a ribbon of build material onto a supply surface of the printer 1800. The provision vessel 1802 includes at least one internal restrictor or baffle 1804 to alter flow of discharge of build material from the provision vessel 1802, as discussed above.

The 3D printer 1800 has a build platform 1806 to form the 3D project. The printer 1800 has a build enclosure 1808 associated with the build platform 1806. In operation, the build platform 1806 may receive build material. In one example, the build platform 1806 is raised to a top portion of the build enclosure 1808 to receive the build material. The build platform 1806 may receive the build material from provision vessel 1802 via the aforementioned supply surface. In other words, the build platform 1806 may receive the ribbon of build material from the supply surface, such as via a powder spreader. On the other hand, in some examples, the material provision vessel 1802 may lay build material directly onto the build platform 1806.

The 3D printer 1800 includes an internal conveying system to provide build material 1810 through a dispense vessel to the material provision vessel 1802. While the flow arrow for the feed build material 1810 is depicted outside of the 3D printer for clarity, the conveying system is internal within the housing of the printer 1800. Further, the printer 1800 may include material cartridge receivers 1812 to hold a material cartridge inserted by a user. The receiver 1812 may make available build material from the material cartridge for the 3D printing.

The printer 1800 may include internal material vessels 1814 to receive build material from the material cartridge in the receiver 1812. The material vessels 1814 may make available build material, such as discharging build material through a feeder for the conveying system. The printer 1800 may also include an internal reclaim material vessel 1816 to receive excess or unfused build material 1818 recovered from the build enclosure 1808. The reclaim material vessel 1816 may discharge build material 1820 to the conveying system. In some operations, the feed build material 1810 may include the build material discharged from the material vessels 1814. In other operations, the feed build material 1810 may additionally include the build material 1820 discharged from the reclaim material vessel 1820. Lastly, in the illustrated example, the 3D printer 1800 has doors or access panels 1822 and a top or lid 1824.

In summary, an example includes a 3D printer having a material provision vessel to discharge build material for a build platform, wherein the 3D printer is to form a 3D object on the build platform from build material. The 3D printer includes a restrictor or baffle disposed internal in the material provision vessel to alter flow of build material discharging from the material provision vessel. The baffle may be multiple baffles. The restrictor or baffle may reduce discharge of the build material from a front portion of the material provision vessel as the material provision vessel operably moves across the supply surface to promote uniformity of build material on the supply surface. In some examples, the restrictor or baffle may additionally facilitate discharge of build material from a back portion of the material provision vessel. The 3D printer may include a powder spreader to distribute the build material discharged from the material provision vessel to across the build platform. The 3D printer may include a supply surface adjacent a build enclosure associated with the build platform, wherein the material provision vessel to discharge the build material onto the supply surface, and wherein the powder spreader to distribute the build material from the supply surface to across the build platform. In some examples, the material provision vessel may operably move in a first direction to discharge the build material onto the supply surface, and wherein the powder spreader to move in a second direction transverse to the first direction to distribute the build material across the build platform. In certain examples, the 3D printer forms the 3D object from successive layers of build material on the build platform, wherein the material provision vessel to discharge successive doses of build material for the successive layers, and wherein the powder spreader to distribute the successive doses of build material as the successive layers of build material across the build platform. In particular examples, the powder spreader may include a roller. Also, the provision vessel may be a dosing vessel.

The material provision vessel may operably move to discharge the build material as a ribbon of build material onto a supply surface adjacent the build platform, wherein the baffle to alter flow includes the baffle to alter flow of build material discharging from the material provision vessel onto the supply surface including to restrict flow of build material discharging from the material provision vessel to increase uniformity of thickness and density of the ribbon. In certain examples, the baffle may be coupled to an inside surface of a vessel wall of the material provision vessel to secure the baffle in the material provision vessel, wherein the baffle reduces a cross-sectional area of an exit of the material provision vessel for the discharge of the build material, wherein the baffle does not extend outside the material provision vessel, and wherein the baffle promotes internal friction reducing discharge flow of the build material from the provision vessel. In one example, the baffle is disposed in a central region of an exit of the material provision vessel for the discharge of the build material, the baffle forming a first zone of the exit on a first side of the baffle and a second zone of the exit on a second side of the baffle. Lastly, in certain examples, the 3D printer may include a dispense vessel to discharge build material through a feeder to the material provision vessel, and a conveying system to provide build material to the dispense vessel, wherein the conveying system, the dispense vessel, and the material provision vessel are internal in the 3D printer. In examples, the material provision vessel is a dosing vessel, dosing container, or dosing box, or any combinations thereof.

Another example includes a 3D printer having a material dosing container to operably move across a supply deck to discharge a ribbon of build material onto the supply deck, wherein the material dosing container comprises an internal restrictor to alter the discharge of build material from the material dosing container. The 3D printer includes a build-material applicator, such as a powder spreader, to distribute build material from the supply deck to across a build platform, wherein the 3D printer generates a 3D object on the build platform from the build material. The internal restrictor may be a baffle to alter flow of build material discharging through an exit opening of the material dosing container to reduce discharge of the build material from a front portion of the exit opening to reduce waste of build material and facilitate discharge of build material from a back portion of the exit opening to promote uniformity of thickness of the ribbon.

Lastly, in general for some examples, a baffle may be something that balks, checks, or deflects. A baffle may be a fixed restrictor, non-moving restrictor, restrictor plate, baffle plate, a flow-restricting baffle, a restrictor baffle designed to moderate discharge rate. A baffle may restrain the flow (e.g., fluid-like flow) of powder, and may be a static or usually static device that regulates the flow of the powder. A baffle may be an obstruction for checking or deflecting the flow of powder or powder-like material. The baffle may be a plate, wall, or solid object to hold back or turn aside the flow of powder, or to deflect, check, or regulate flow of powder or passage of powder. In some examples, a baffle may be a plate having a generally flat surface that controls or directs the flow of powder or powder-like material. A baffle may dampen flow of powder or powder-like material. A baffle may include a surface placed inside an open area, region, or volume to inhibit direct motion of powder flow without preventing motion altogether of the powder flow.

While the present techniques may be susceptible to various modifications and alternative forms, the examples discussed above have been shown by way of example. It is to be understood that the technique is not intended to be limited to the particular examples disclosed herein. Indeed, the present techniques include all alternatives, modifications, and equivalents falling within the scope of the present techniques.

What is claimed is:

1. A three-dimensional (3D) printer comprising:
a material provision vessel to discharge build material for a build platform, wherein the 3D printer is to form a 3D object on the build platform from build material; and
a baffle disposed internal in the material provision vessel to alter flow of build material discharging from the material provision vessel.

2. The 3D printer of claim 1, comprising a powder spreader to distribute the build material discharged from the material provision vessel to across the build platform, wherein the baffle is coupled to an inside surface of the material provision vessel.

3. The 3D printer of claim 2, comprising a supply surface adjacent a build enclosure associated with the build platform, wherein the material provision vessel to discharge the build material onto the supply surface, wherein the powder spreader to distribute the build material from the supply surface to across the build platform, and wherein an end of the baffle is coupled to the inside surface.

4. The 3D printer of claim 3, wherein the baffle comprises multiple baffles each having a normal vertical orientation or an angled vertical orientation, wherein the material provision vessel to operably move in a first direction to discharge the build material onto the supply surface, and wherein the powder spreader to move in a second direction transverse to the first direction to distribute the build material across the build platform.

5. The 3D printer of claim 3, wherein the baffle extends along an inside length of the material provision vessel, wherein the baffle to reduce discharge of the build material from a front portion of the material provision vessel and facilitate discharge of build material from a back portion of the material provision vessel as the material provision vessel operably moves across the supply surface to promote uniformity of build material on the supply surface.

6. The 3D printer of claim 2, wherein the 3D printer to form the 3D object from successive layers of build material on the build platform, wherein the material provision vessel to discharge successive doses of build material for the successive layers, and wherein the powder spreader to distribute the successive doses of build material as the successive layers of build material across the build platform.

7. The 3D printer of claim 1, wherein the powder spreader comprises a roller, wherein the provision vessel comprises a dosing vessel, wherein the baffle is disposed in a central region of an exit of the material provision vessel for the discharge of the build material, the baffle forming a first zone of the exit on a first side of the baffle and a second zone of the exit on a second side of the baffle.

8. The 3D printer of claim 1, wherein the material provision vessel to operably move to discharge the build material as a ribbon of build material onto a supply surface adjacent the build platform, wherein the baffle to alter flow comprises the baffle to alter flow of build material discharging from the material provision vessel onto the supply surface comprising to restrict flow of build material discharging from the material provision vessel to increase uniformity of thickness and density of the ribbon.

9. The 3D printer of claim 1, wherein the baffle is coupled to an inside surface of a vessel wall of the material provision vessel to secure the baffle in the material provision vessel, wherein the baffle reduces a cross-sectional area of an exit of the material provision vessel for the discharge of the build material, wherein the baffle does not extend outside the material provision vessel, and wherein the baffle promotes internal friction reducing discharge flow of the build material from the provision vessel.

10. The 3D printer of claim 1, comprising:
a dispense vessel to discharge build material through a feeder to the material provision vessel, wherein the baffle comprises multiple baffles; and
a conveying system to provide build material to the dispense vessel, wherein the conveying system, the dispense vessel, and the material provision vessel are internal in the 3D printer, and wherein the material provision vessel comprises a dosing vessel, dosing container, or dosing box, or any combinations thereof.

11. A three-dimensional (3D) printer comprising:
a material dosing container to operably move across a supply deck to discharge a ribbon of build material onto the supply deck, wherein the material dosing container comprises an internal restrictor to alter the discharge of build material from the material dosing container; and
a build-material applicator to distribute build material from the supply deck to across a build platform, wherein the 3D printer is to generate a 3D object on the build platform from the build material.

12. The 3D printer of claim 11, wherein the internal restrictor to alter the discharge comprises the internal restrictor comprising a baffle to alter flow of build material discharging through an exit opening of the material dosing container to reduce discharge of the build material from a front portion of the exit opening to reduce waste of build material and facilitate discharge of build material from a back portion of the exit opening to promote uniformity of thickness of the ribbon, and wherein the build-material applicator comprises a powder spreader.

13. A method of operating a three-dimensional (3D) printer, comprising:
discharging build material from a provision vessel as a ribbon of build material onto a supply surface;
altering, via an internal baffle in the provision vessel, flow of build material discharging from the provision vessel onto the supply surface to promote uniformity of thickness of the ribbon;
distributing, via a powder spreader, build material from the supply surface to across a build platform; and
forming a 3D object from the build material on the build platform.

14. The method of claim 13, comprising moving the provision vessel across the supply surface to discharge the build material as the ribbon, wherein altering flow via the internal baffle comprises reducing discharge of the build material from a front portion of the provision vessel and promoting discharge of build material from a back portion of the material provision vessel.

15. The method of claim 13, wherein altering flow via the internal baffle comprises increasing internal friction reducing discharge flow of the build material from the provision vessel, wherein the internal baffle is coupled to an inside surface of the provision vessel, wherein the internal baffle reduces a cross-sectional area of an exit of the material provision vessel, the exit for the discharging of the build material, and wherein the internal baffle does not extend outside the provision vessel.
